(19) United States
(12) Patent Application Publication
(10) Pub. No.: US 2010/0291518 A1
(43) Pub. Date: Nov. 18, 2010

(54) INTERACTIVE DIGITAL LEARNING SYSTEM AND METHOD USING MULTIPLE REPRESENTATIONS TO ASSIST IN GEOMETRY PROOFS

(76) Inventors: Wing-Kwong WONG, Yunlin County (TW); Hsi-Hsun Yang, Youlin County (TW); Sheng-Kai Yin, Yunlin County (TW)

Correspondence Address: Muncy, Geissler, Olds & Lowe, PLLC, 4000 Legato Road, Suite 310, FAIRFAX, VA, 22033, US

(21) Appl. No.: 12/464,479

(22) Filed: May 12, 2009

(51) Int. Cl. G09B 19/00; G06F 17/30; G09B 23/04; G09B 7/00

(52) U.S. Cl. 434/211; 434/350; 707/E17.044; 707/710

(57) ABSTRACT

The present invention discloses an interactive digital learning system and method using multiple representations to assist in geometry proofs. The system of the present invention links to a computer and comprises a database, a problem representation unit, a proof representation unit and a visual representation unit. The database respectively links to the computer, problem representation unit, proof representation unit and visual representation unit and has a geometry proof problem containing a given condition, a prove statement, a static geometric figure and a solution. The problem representation unit displays the geometry proof problem. The solution is presented in a formal proof unit and a proof tree unit in form of short-answer questions, multi-choice questions and logic arrangement tests to train students. The visual representation unit presents the static geometric figure and a dynamic geometric figure to deepen the students' comprehension on geometry proof problem.

### FIELD OF THE INVENTION

The present invention relates to a method for learning geometry proofs, particularly to an interactive digital learning system and method using multiple representations to assist in geometry proofs.

### BACKGROUND OF THE INVENTION

A general mathematical concept usually has a formal and strict conceptual definition. However, when facing a mathematical problem, students do not always examine the problem from the related conceptual definition but usually use a so-called concept image to solve the problem. The concept image used in considering a geometry problem comes from the visual experiences and the operational experiences in the daily living environment. Contrarily, students do not grasp a conceptual definition until the latter stage of learning. Therefore, students do not cognize a geometric figure via a conceptual definition but via a concept image at the beginning.

Learning usually begins from imitation. In geometry instruction, a teacher usually gives a conceptual definition firstly and next instructs the steps of solving a geometry proof problem, and then students learn it. However, such a traditional instruction method is likely to become a process of imitation and recitation and result in the following problems: 1. Students do not know how to set about a geometry problem; 2. Students depend on classic images and concept images; 3. Student cannot comprehend mathematical symbols but solve problems instinctively by visual experiences; 4. Students cannot grasp the exact target of a problem; 5. Students lack a full integration ability; 6. The solution of a problem is usually too brief; 7. Students are apt to neglect some steps.

A Dutch mathematical educationist Van Hiele proposed in 1986 that the process of learning geometry includes five stages: (0) Visualization: A student recognizes a figure from its shape but does not understand the abstract meaning of the figure; (1) Analysis: The student can analyze the construction of the figure but cannot explain; (2) Informal deduction: The student can understand the relationship among different figures; (3) Formal deduction: The student can construct a figure according to the geometric theorems, but the result is not always correct; (4) Conscientiousness: The student can perform analysis and comparison and establish a new theorem. Therefore, the development of geometric ability begins from visual learning. For a beginner, a concept image is much more important than a conceptual definition. Hence, images are much more useful for a beginner.

At present, computer systems have been able to implement complicated geometry proofs, such as GSP and GEX. GSP denotes Geometer's Sketchpad, which is a commercial product sponsored by National Science Foundation in 1991. In recent years, scholars, such as Cyuan Ren Chong, Lin Boa Pin, Wu Jheng Syun, Chen Chuang Yi, et al., are pushing the popularization of GSP in Taiwan. GEX denotes Geometry Expert, which was designed by three Chinese scholars Gao Siao Shan, Chang Jing Jhong, and Jhou Sian Cing in 1998. GEX not only can provide figure presentation and visual and interactive dynamical geometric figures but also can prove geometric theorems in a mechanical way. GEX is a geometric proving system incorporating the geometric proving methods used before. The symbols used in GEX are different from the common mathematical symbols and harder to understand. However, it is a tool useful for mathematicians.

Thus, the Inventors propose a teaching system to overcome the abovementioned problems and promote the quality of geometry teaching.

### SUMMARY OF THE INVENTION

The primary objective of the present invention is to provide an interactive digital learning system and method using multiple representations to assist in geometry proofs, whereby students can comprehend and acquaint themselves with the modes of geometry proof problems.

To achieve the abovementioned objective, the present invention proposes an interactive digital learning system and method using multiple representations to assist in geometry proofs. The system of the present invention links to a computer and comprises a database, a problem representation unit and a proof representation unit. The database links to the computer. The database has at least one geometry proof problem containing at least one given condition, at least one prove statement (statement of what is to be proved in the problem), a static geometric figure, and a solution corresponding to the problem. The problem representation unit links to the computer and retrieves the given condition, at least one prove statement and the corresponding static geometric figure from the database via the computer. The proof representation unit links to the database and the problem representation unit and displays the solution corresponding to the problem. The solution is presented in a formal proof unit and a proof tree unit.

The system of the present invention also comprises a visual representation unit linking to the database and the problem representation unit. The visual representation unit presents the static geometric figure and a dynamic geometric figure, which meet the given condition and the prove statement.

The formal proof unit and the proof tree unit are respectively presented in form of a plurality of solution steps and a plurality of solution nodes. The method of the present invention comprises steps: inputting into the computer a geometry proof problem including at least one given condition, at least one prove statement, a static geometric figure and a solution corresponding to the geometry proof problem; the computer processing the geometry proof problem and presenting the solution in form of a plurality of solution steps and a plurality of solution nodes arranged in a tree-like structure; presenting the solution steps in form of multi-choice questions, logic arrangement tests and short-answer questions, and presenting the solution nodes in form of multi-choice questions and short-answer questions. In the abovementioned steps, the visual representation unit, which links to the problem representation unit, presents the static geometric figure and a dynamic geometric figure.

Based on the abovementioned technical schemes, the interactive digital learning system and method using multiple representations to assist in geometry proofs of the present invention has the following advantages:
1. In comparison with the conventional teaching method, the present invention can provide a full logic concept image to fast and correctly establish a conceptual definition when a student is solving a geometry proof problem;
2. The formal proof unit, the proof tree unit and the visual representation unit can help students to solve a problem with a correct process, form a clear concept image, acquaint themselves with mathematical symbols, analyze the problem, integrate mathematical concepts, solve geometric proof problem with less instinct and visual experiences, and establish complete steps of solving a problem, whereby students can be familiar with concepts of geometric mathematics and improve the reasoning and conception abilities thereof.

### BRIEF DESCRIPTION OF THE DRAWINGS

FIG. 1 is a diagram schematically showing a system according to the present invention;

FIG. 2 is a diagram schematically showing the interaction of the units of a user interface of the system according to the present invention;

FIG. 3 is a diagram schematically showing a user interface of the system according to the present invention;

FIG. 4 is a diagram schematically showing a function of a proof tree unit of the system according to the present invention;

FIG. 5 is a diagram schematically showing a function of a formal proof unit of the system according to the present invention;

FIG. 6 is a diagram schematically showing another function of the formal proof unit of the system according to the present invention;

FIG. 7 is a diagram schematically showing a function of a problem representation unit and the formal proof unit of the system according to the present invention; and

FIG. 8 is a flowchart of a method according to the present invention.

### DETAILED DESCRIPTION OF THE PREFERRED EMBODIMENTS

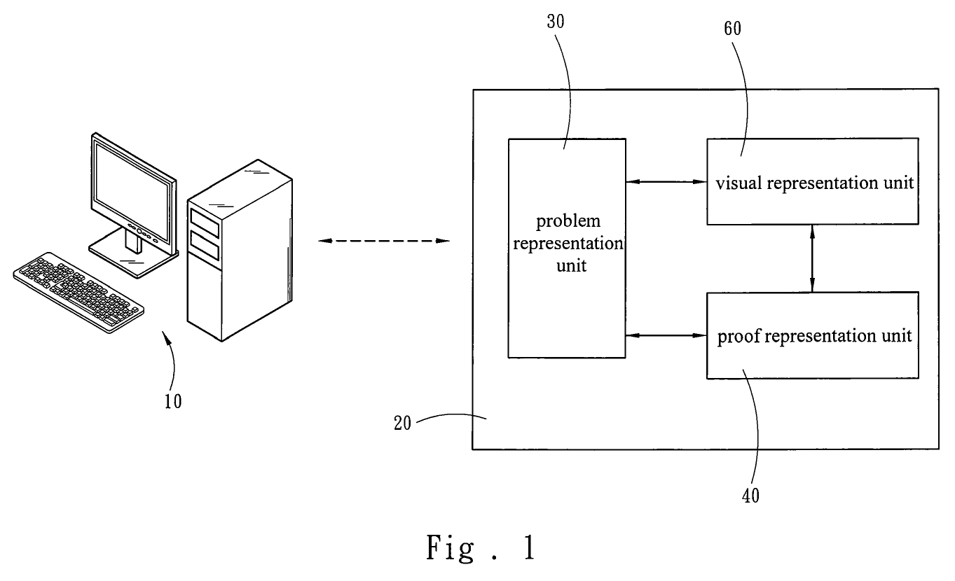

Refer to from FIG. 1 to FIG. 3. The present invention proposes an interactive digital learning system and method using multiple representations to assist in geometry proofs, which links to a computer 10 and comprises a database 20, a problem representation unit 30, and a proof representation unit 40. The database 20 links to the computer 10 and contains at least one problem (not shown in the drawings). The problem has at least one given condition 31, at least one prove statement 32 (statement of what is to be proved in the problem), a static geometric FIG. 61 and a corresponding solution 50. The computer 10 also provides an Internet access (not shown in the drawings). The problem representation unit 30 links to the computer 10 and retrieves the given condition 31, the prove statement 32 and the corresponding static geometric FIG. 61 from the database 20 via the computer 10. Then, the problem representation unit 30 displays the given condition 31, the prove statement 32 and the corresponding static geometric FIG. 61.

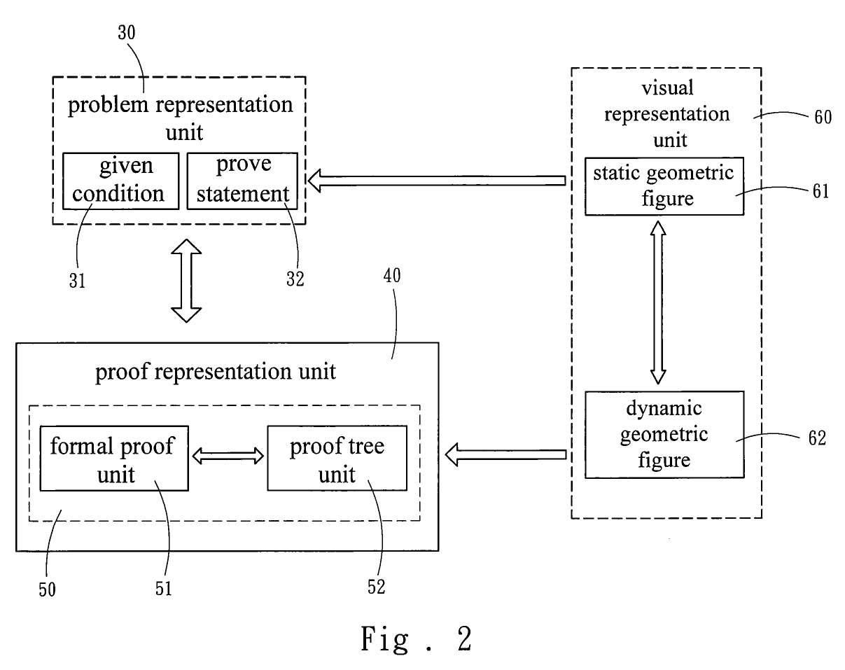

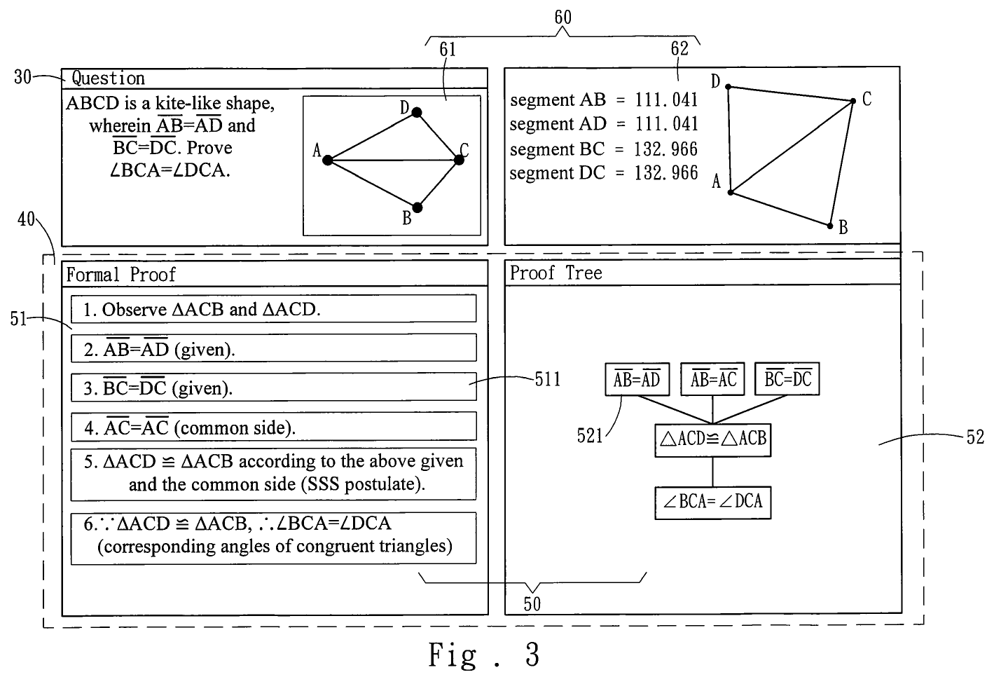

The proof representation unit 40 links to the database 20 and the problem representation unit 30 and displays the solution 50 corresponding to the problem. In FIG. 2 and FIG. 3, the solution 50 is expressed by a formal proof unit 51 and a proof tree unit 52.

The system of the present invention also comprises a visual representation unit 60 linking to the database 20 and the problem representation unit 30. The visual representation unit 60 contains the static geometric FIG. 61 and a dynamic geometric FIG. 62. The visual representation unit 60 meets the given condition 31 and the prove statement 32. The static geometric FIG. 61 links to the problem representation unit 30 and the proof representation unit 40, and the linkage thereof is expressed by figures, colors, lines, or a combination of figures, colors and lines. For example, the given condition 31 and the prove statement 32 are visually highlighted with figures, colors, lines, etc. in the sides, apexes, and characters of the static geometric figure. The formal proof unit 51 and the proof tree unit 52 are also visually highlighted in the same way.

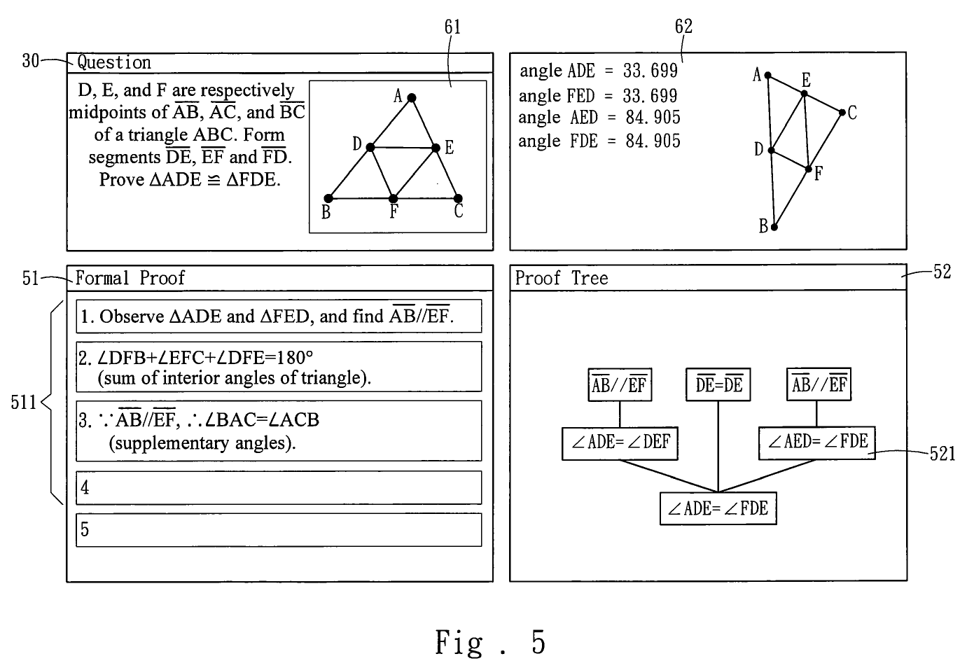

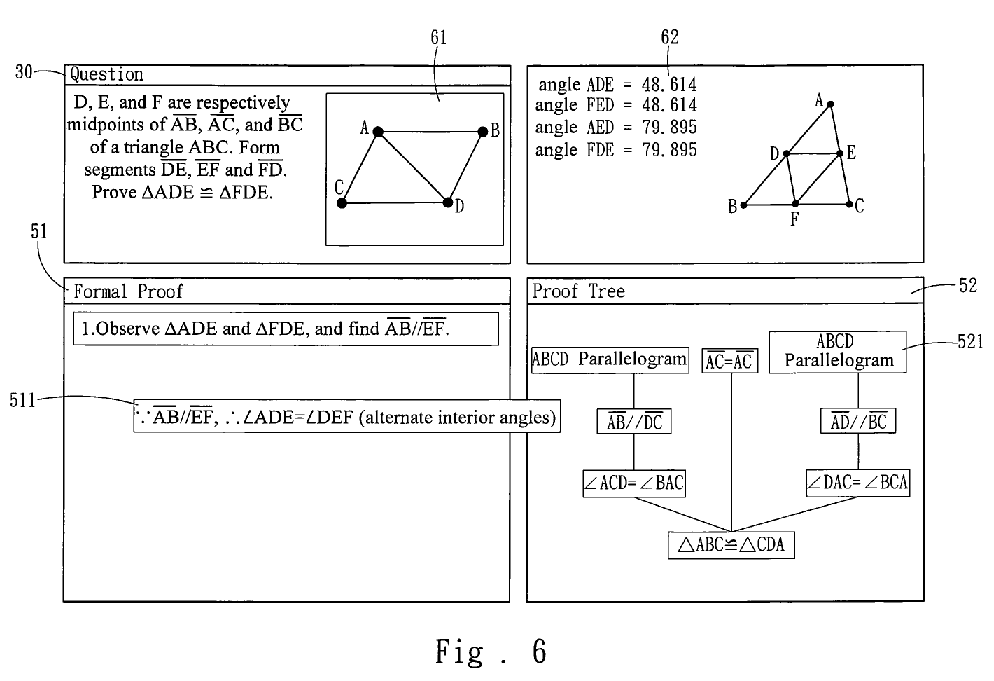

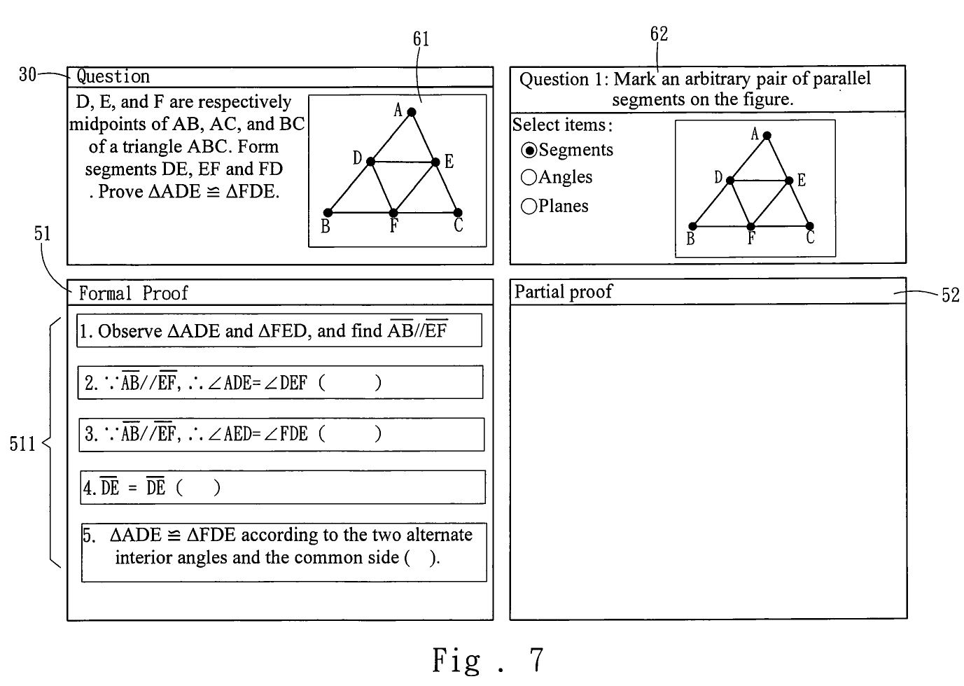

Refer to from FIG. 3 to FIG. 8. The proof tree unit 52 of the solution 50 is expressed by a plurality of solution nodes 521 arranged in a tree-like structure. The solution node 521 may be in form of a multi-choice question, a short-answer question or a combination of a multi-choice question and a short-answer question. As shown in FIG. 5 and FIG. 6, the formal proof unit 51 of the solution 50 is expressed by a plurality of solution steps 511. The solution step 511 may be in form of a multi-choice question, a logic arrangement test, a short-answer question or a combination of a multi-choice question, a logic arrangement test and a short-answer question. In FIG. 5, the solution step 511 is in form of a short-answer question. In FIG. 6, the solution step 511 is in form of a combination of a multi-choice question and a logic arrangement test. In FIG. 7, both the formal proof unit 51 and the proof tree unit 52 are in form of short-answer questions.

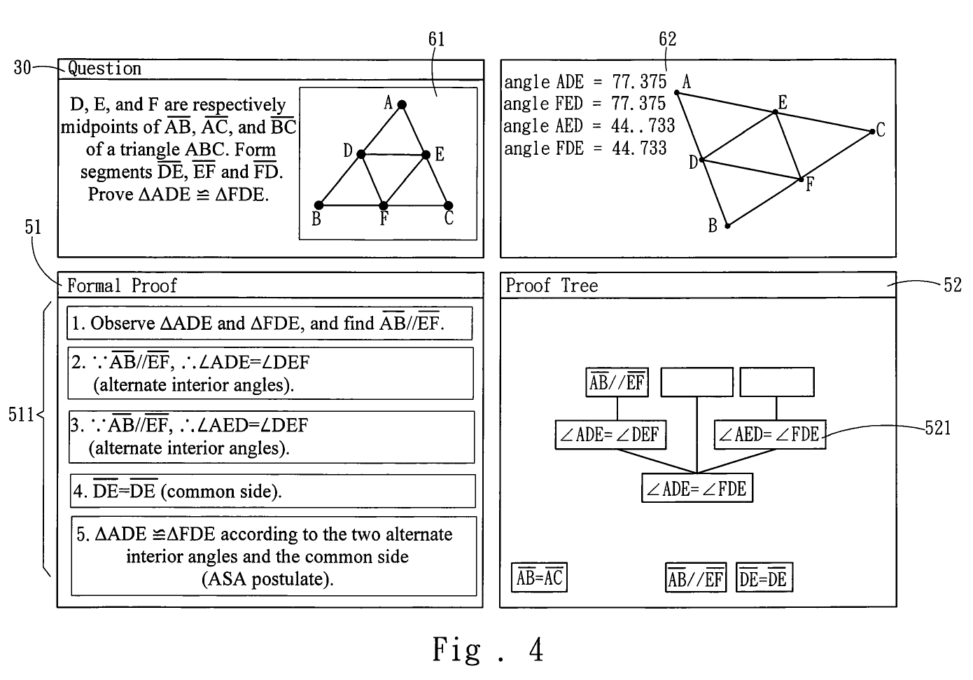

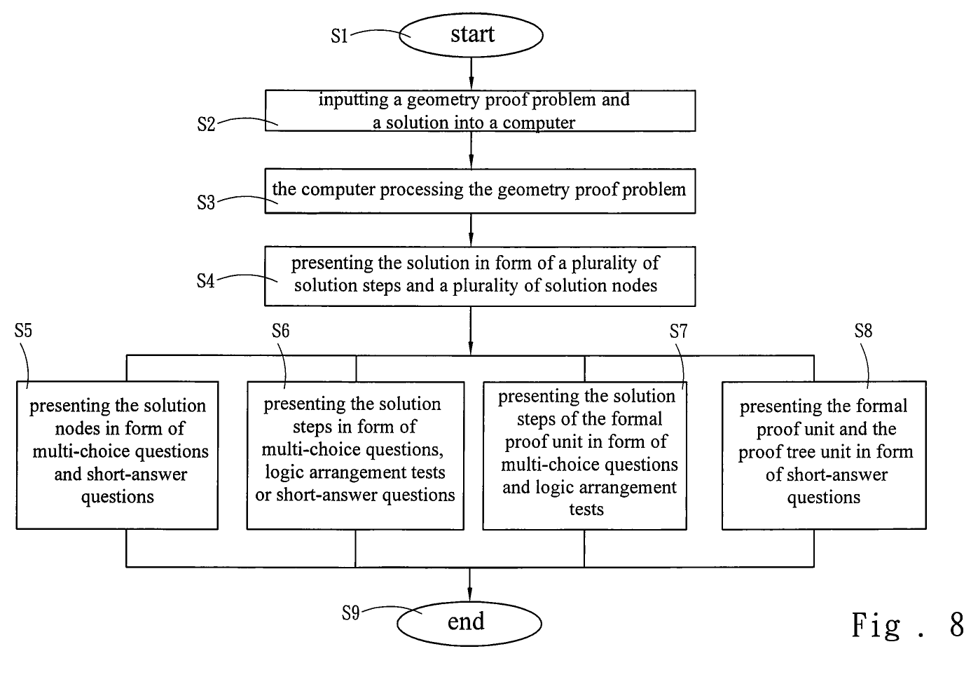

Refer to FIG. 8 a flowchart of the method of the present invention. In Step S1, the system of the present invention is started. In Step S2, a geometry proof problem (not shown in the drawings), including a given condition 31, a prove statement 32, a static geometric FIG. 61 and a solution 50 are input into a computer 10. In Step S3, the computer 10 processes the geometry proof problem. In Step S4, the solution 50 is expressed by solution steps 511 and solution nodes 521. In Step S5, the solution steps 511 are completely presented, and the solution nodes 521 are in form of a combination of short-answer questions and multi-choice questions, as shown in FIG. 4. In FIG. 4, the short-answer questions of the solution nodes 521 are used to provide the exercise of the logic of a geometry proof for students.

In Step S6, the proof tree unit 52 completely presents the solution 50, the solution steps 511 are in form of multi-choice questions, logic arrangement tests, short-answer questions or a combination of multi-choice questions, logic arrangement tests and short-answer questions, as shown in FIG. 5. In FIG. 5, the short-answer questions of the solution steps 511 are used to make the user familiar with the steps of solving a geometry proof problem.

In Step S7, the proof tree unit 52 completely presents the solution 50, the solution steps 511 of the formal proof unit 51 are in form of multi-choice questions and logic arrangement tests, as shown in FIG. 6. In FIG. 6, the logic arrangement tests of the solution steps 511 are used to provide the exercise of the logic of a geometry proof for students.

In Step S8, both the formal proof unit 51 and the proof tree unit 52 are in form of short-answer questions, as shown in FIG. 7. In FIG. 7, the exercises in the formal proof unit 51 and the problem representation unit 30 can train students to fully comprehend the geometry proof problem. In Step S9, the exercise ends. As the visual representation unit 60 links to the problem representation unit 30, the static geometric FIG. 61 and a dynamic geometric FIG. 62 both corresponding to the geometry proof problem are presented in the abovementioned steps, whereby students can learn geometric knowledge in diversified manners.

In a conventional process of learning geometry, students read a correct geometry proof, and then imitate the proof, decode the proof, understand the proof literally, understand the proof deductively, interpret the proof, and finally write down the proof. However, such a conventional learning process is likely to result in a conflict between the conceptual definition and the concept image.

Thus, Behr, et al. proposed a theory of multiple representations, wherein a representation refers to multiple concretization of a concept. The representations may be divided into external representations and internal representations. External representations are the explicit expressions of internal representations, such as the symbol systems used in mental activities, including symbols, forms, figures, equations, and characters. What the present invention pertains to is the external representations.

Duval further proposed that coordinating different representations can fulfill the development of a mathematical concept, whereby students can smoothly and precisely transform the representations into a mathematical concept or amend the cognition of a mathematical concept via diversified descriptions and the comparisons therebetween.

In conclusion, the present invention helps students achieve a complete logic concept image and attain the best result of study. In comparison with the conventional teaching methods, the present invention can help students fast and correctly establish a conceptual definition. The present invention has the following advantages: (1) providing a multi-representation learning environment for students, including figures, colors, symbols (e.g. the visual representation unit 60), and texts; (2) providing the interactive relationship among the problem, proof steps, texts and figures; (3) providing a proof representation unit 40 enabling students to interact with the given condition, conclusion and theorems.

In the present invention, the formal proof unit 51 is in form of multi-choice questions, logic arrangement tests, or short-answer questions; the proof tree unit 52 is in form of multi-choice questions and short-answer questions. The diversified exercises can help students construct a concept image, acquaint themselves with mathematical symbols, comprehend what is to be proved in the problem, and integrate concepts, whereby students can solve a problem with less instinct and more complete steps. Further, the diversified exercises can deepen the comprehension in geometric mathematical concepts.

Jonassen proposed in 1996 “Knowledge about computer, Knowledge from computer, Knowledge by computer”. One learns knowledge about computer to possess ability of operating a computer. Then, he can conveniently access the world of knowledge via a computer and a network. When he learns knowledge arranged or processed by computer-based technologies, he can grasp the knowledge more efficiently. Accordingly, the present invention adopts the computer technology and the multi-representation teaching concept to solve the conventional learning problem and help students learn correct knowledge from the beginning.

What is claimed is:

1. An interactive digital learning system using multiple representations to assist in geometry proofs, which links to a computer, comprising
a database linking to said computer and containing at least one problem, wherein said problem has at least one given condition, at least one prove statement, a static geometric figure, and a solution corresponding to said problem;
a problem representation unit linking to said computer, retrieving said given condition, at least one said prove statement and said static geometric figure from said database via said computer, and displaying said given condition, at least one said prove statement and said static geometric figure; and
a proof representation unit linking to said database and said problem representation unit and displaying said solution corresponding to said problem, wherein said solution is expressed by a formal proof unit and a proof tree unit.

2. The interactive digital learning system using multiple representations to assist in geometry proofs according to claim 1 further comprising a visual representation unit linking to said database and said problem representation unit, meeting said given condition and said prove statement, and containing said static geometric figure and a dynamic geometric figure.

3. The interactive digital learning system using multiple representations to assist in geometry proofs according to claim 2, wherein said static geometric figure links to said problem representation unit and said proof representation unit; and a linkage of said static geometric figure, said problem representation unit and said proof representation unit is expressed by figures, colors, lines, or a combination of figures, colors and lines.

4. The interactive digital learning system using multiple representations to assist in geometry proofs according to claim 1, wherein said proof tree unit of said solution is expressed by a plurality of solution nodes arranged in a tree-like structure.

5. The interactive digital learning system using multiple representations to assist in geometry proofs according to claim 4, wherein said solution nodes are in form of multi-choice questions or short-answer questions or a combination of multi-choice questions and short-answer questions.

6. The interactive digital learning system using multiple representations to assist in geometry proofs according to claim 1, wherein said formal proof unit of said solution is expressed by a plurality of solution steps.

7. The interactive digital learning system using multiple representations to assist in geometry proofs according to claim 6, wherein said solution steps are in form of multi-choice questions, logic arrangement tests or short-answer questions or a combination of multi-choice questions, logic arrangement tests and short-answer questions.

8. The interactive digital learning system using multiple representations to assist in geometry proofs according to claim 1, wherein said computer provides an Internet access.

9. An interactive digital learning method using multiple representations to assist in geometry proofs, which is realized by a computer, comprising
inputting into said computer a geometry proof problem including at least one given condition, at least one prove statement, a static geometric figure and a solution corresponding to said geometry proof problem;
said computer processing said geometry proof problem and presenting said solution in form of a plurality of solution steps and a plurality of solution nodes arranged in a tree-like structure; and
presenting said solution nodes in form of multi-choice questions and short-answer questions.

10. The interactive digital learning method using multiple representations to assist in geometry proofs according to claim 9, wherein said static geometric figure is generated according to said geometry proof problem; a dynamic geometric figure is generated to meet said given condition and said prove statement.

11. An interactive digital learning method using multiple representations to assist in geometry proofs, which is realized by a computer, comprising
inputting into said computer a geometry proof problem including at least one given condition, at least one prove statement, a static geometric figure and a solution corresponding to said geometry proof problem;
said computer processing said geometry proof problem and presenting said solution in form of a plurality of solution steps and a plurality of solution nodes arranged in a tree-like structure; and
presenting said solution steps in form of multi-choice questions, logic arrangement tests or short-answer questions.

12. The interactive digital learning method using multiple representations to assist in geometry proofs according to claim 11, wherein said static geometric figure is generated according to said geometry proof problem; a dynamic geometric figure is generated to meet said given condition and said prove statement.
